(19) United States
(12) Patent Application Publication
(10) Pub. No.: US 2026/0148312 A1
(43) Pub. Date: May 28, 2026

(54) DYNAMIC TRUST-WEIGHTED CAPITAL ALLOCATION AND INSURANCE UNDERWRITING ENGINE

(71) Applicant: George William Bickerstaff, III, Greenwich, CT (US)

(72) Inventor: George William Bickerstaff, III, Greenwich, CT (US)

(21) Appl. No.: 19/452,430

(22) Filed: Jan. 19, 2026

(51) Int. Cl. G06Q 40/08

(52) U.S. Cl. CPC G06Q 40/082; G06Q 2220/00

(57) ABSTRACT

A dynamic trust-weighted capital allocation and insurance underwriting engine adjusts financial risk parameters in real time using cryptographically verifiable trust signals, outcome attribution records, and governance indicators. Composite trust scores drive automated modification of capital reserves, insurance pricing, and lending terms, enabling transparent, auditable, and continuously adaptive financial risk management across banking, insurance, and decentralized finance systems.

### TECHNICAL FIELD

The present invention relates to computer-implemented systems for financial risk management, capital allocation, and insurance underwriting.

More particularly, the invention relates to systems and methods that dynamically adjust capital reserves, insurance premiums, coverage limits, lending terms, underwriting eligibility, or risk-transfer parameters in real time based on cryptographically verifiable trust signals, outcome attribution records, and governance compliance indicators.

### BACKGROUND

Financial institutions, insurers, lenders, and decentralized finance platforms allocate capital and price risk using actuarial tables, historical loss data, credit scores, static risk models, and periodic audits.

Such approaches rely on lagging indicators and infrequent reassessments that fail to reflect real-time changes in decision quality, operational governance, or outcome performance.

In regulated sectors such as healthcare finance, banking, insurance, infrastructure investment, and public-sector risk pooling, decision quality and governance compliance directly influence loss severity, claim frequency, default risk, and capital adequacy.

Existing underwriting and capital allocation systems generally lack mechanisms to incorporate continuous, verifiable signals derived from real-world outcomes and governance behavior.

As a result, capital is frequently mispriced, reserves are inefficiently allocated, and high-performing entities subsidize poor decision-makers, increasing systemic risk.

Decentralized finance systems face similar limitations, as risk parameters are often static, governance is fragmented, and trust signals are difficult to verify without centralized intermediaries.

Accordingly, there exists a need for a technical system that dynamically and transparently adjusts financial risk parameters using verifiable trust signals linked to real-world decision outcomes and governance quality.

### SUMMARY OF THE INVENTION

The disclosed invention provides a dynamic trust-weighted capital allocation and insurance underwriting engine.

A trust signal ingestion engine collects cryptographically verifiable trust inputs including outcome attribution records, governance compliance indicators, influence metrics, and operational performance signals.

A verification layer authenticates trust signal integrity, provenance, and freshness before financial use.

A trust normalization and weighting engine computes composite trust scores reflecting decision quality, outcome reliability, governance adherence, and systemic risk contribution.

A financial adjustment engine dynamically modifies capital reserves, insurance premiums, coverage limits, lending rates, collateral requirements, or underwriting eligibility based on the composite trust scores.

A governance and audit engine enforces policy and regulatory constraints and generates cryptographically signed financial adjustment records for audit, supervision, and dispute resolution.

### DEFINITIONS

Capital Allocation Parameter: A financial variable including capital reserve levels, liquidity buffers, lending limits, or collateral requirements.

Composite Trust Score: A normalized, weighted score derived from multiple verifiable trust signals representing decision quality, governance compliance, and outcome performance.

Financial Adjustment Record: A cryptographically signed record documenting a dynamic change to underwriting terms, pricing, or capital allocation.

Governance Signal: A verifiable indicator of policy compliance, regulatory adherence, audit outcomes, or operational governance behavior.

Influence Signal: A measure of decision authority, systemic impact, or responsibility derived from verified roles, scale of operations, or network position.

Outcome Attribution Record: A cryptographic artifact linking real-world outcomes to specific decisions, actors, systems, or operational units.

Risk Weighting Function: A mathematical function that adjusts trust signal influence based on volatility, uncertainty, or systemic exposure.

Trust Signal: Any cryptographically verifiable input representing credibility, reliability, influence, governance quality, or performance.

Underwriting Parameter: A financial variable including insurance premiums, deductibles, coverage limits, exclusions, or policy eligibility.

Verification Layer: A system component that validates the authenticity, integrity, and freshness of trust signals prior to financial use.

### BRIEF DESCRIPTION OF THE DRAWINGS

FIG. 1 illustrates a dynamic trust-weighted capital allocation and underwriting system architecture.

FIG. 2 illustrates trust signal ingestion, verification, and normalization.

FIG. 3 illustrates composite trust score computation and risk adjustment.

FIG. 4 illustrates dynamic financial adjustment and governance enforcement.

FIG. 5 illustrates applications across banking, insurance, and decentralized finance systems.

### DETAILED DESCRIPTION

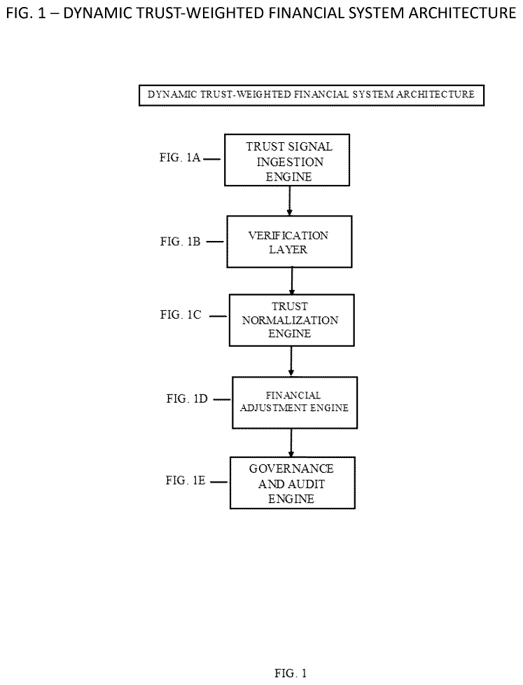

### FIG. 1—Dynamic Trust-Weighted Financial System Architecture

FIG. 1 illustrates a system architecture comprising a trust signal ingestion engine, a verification layer, a trust normalization and weighting engine, a financial adjustment engine, and a governance and audit engine operating as coordinated but logically distinct subsystems. Separation of trust evaluation from financial execution ensures transparency, scalability, and regulatory compliance. All trust evaluations and financial actions are cryptographically verifiable and auditable.

### FIG. 1A—Trust Signal Ingestion Engine

FIG. 1A illustrates a trust signal ingestion engine configured to receive trust signals from internal systems and external sources. Trust signals include outcome attribution records, governance signals, influence signals, and operational performance metrics. Each signal is timestamped and associated with a verified source identity.

### FIG. 1B—Verification Layer

FIG. 1B illustrates a verification layer that validates trust signal authenticity, integrity, and freshness using cryptographic verification techniques. Signals failing verification are rejected or down-weighted. This layer prevents manipulation, spoofing, and stale data from influencing financial decisions.

### FIG. 1C—Trust Normalization Engine

FIG. 1C illustrates normalization of heterogeneous trust signals into a unified numerical and semantic framework. Normalization accounts for scale, domain context, and reliability. The resulting normalized trust vectors enable consistent downstream processing.

### FIG. 1D—Financial Adjustment Engine

FIG. 1D illustrates a financial adjustment engine that applies composite trust scores to financial parameters. Adjustments may occur continuously or at defined intervals and remain bounded by policy and regulatory constraints. Financial execution is automated yet controlled.

### FIG. 1E—Governance and Audit Engine

FIG. 1E illustrates a governance and audit engine that records trust evaluations and financial adjustments in an immutable log. Cryptographically signed financial adjustment records support regulatory review, internal audit, and dispute resolution.

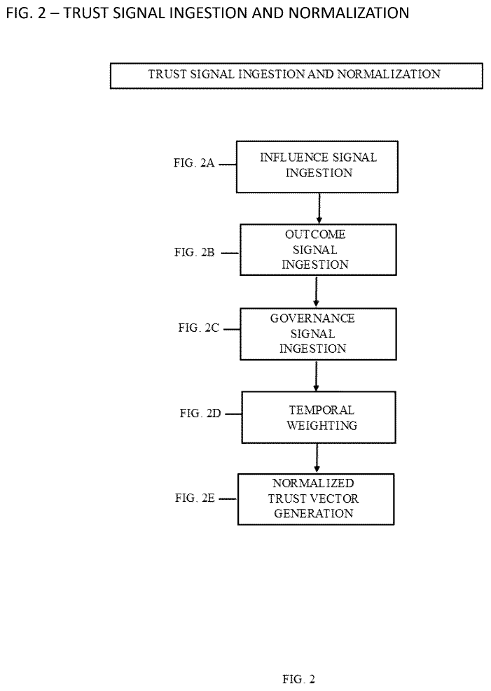

### FIG. 2—Trust Signal Ingestion and Normalization

FIG. 2 illustrates preprocessing of trust signals prior to composite scoring. Signals originate from multiple domains and systems. Verification and normalization ensure consistency and reliability.

### FIG. 2A—Influence Signal Ingestion

FIG. 2A illustrates ingestion of influence signals reflecting decision authority and systemic impact. Influence scaling mitigates risk concentration and accounts for responsibility proportionality.

### FIG. 2B—Outcome Signal Ingestion

FIG. 2B illustrates ingestion of outcome attribution records tied to real-world outcomes such as loss avoidance, claim reduction, or performance improvement. Attribution ensures fairness and accuracy.

### FIG. 2C—Governance Signal Ingestion

FIG. 2C illustrates ingestion of governance signals including audit outcomes, compliance status, and policy adherence. Strong governance increases trust weighting and reduces capital cost.

### FIG. 2D—Temporal Weighting

FIG. 2D illustrates application of temporal decay functions to trust signals so that recent performance has greater influence than historical data. Risk assessment remains current.

### FIG. 2E—Normalized Trust Vector Generation

FIG. 2E illustrates generation of normalized trust vectors representing multiple trust dimensions. Vectors provide explainability for financial decisions.

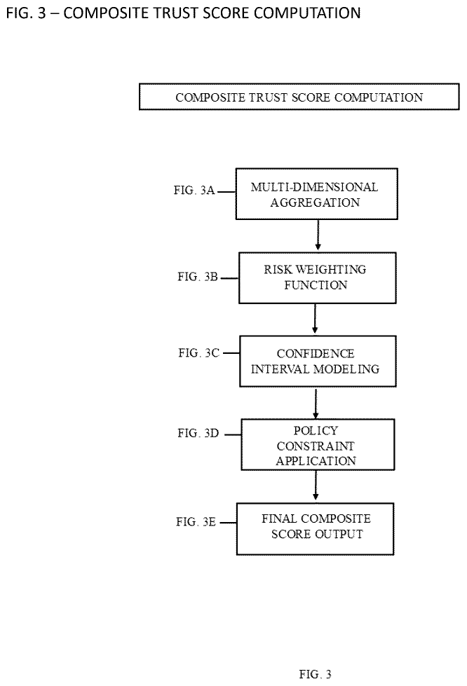

### FIG. 3—Composite Trust Score Computation

FIG. 3 Illustrates Computation of Composite Trust Scores From normalized trust vectors. Scores represent actionable risk metrics and are auditable.

### FIG. 3A—Multi-Dimensional Aggregation

FIG. 3A illustrates aggregation of trust dimensions including outcome quality, governance compliance, and influence. Weighting is configurable by policy.

### FIG. 3B—Risk Weighting Function

FIG. 3B illustrates application of risk weighting functions that adjust trust scores based on volatility and uncertainty. Stable performance is rewarded.

### FIG. 3C—Confidence Interval Modeling

FIG. 3C illustrates computation of confidence bounds around trust scores. Uncertainty drives conservative financial adjustments.

### FIG. 3D—Policy Constraint Application

FIG. 3D illustrates enforcement of regulatory and contractual constraints on trust scores. Minimum requirements and exclusions are applied automatically.

### FIG. 3E—Final Composite Score Output

FIG. 3E illustrates generation of cryptographically signed composite trust scores. Scores are immutable and verifiable.

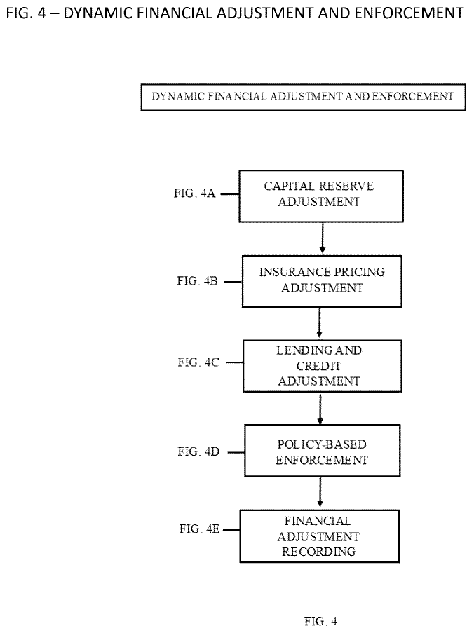

### FIG. 4—Dynamic Financial Adjustment and Enforcement

FIG. 4 illustrates real-time financial parameter adjustment driven by composite trust scores. Adjustments are continuous, explainable, and bounded.

### FIG. 4A—Capital Reserve Adjustment

FIG. 4A illustrates modification of capital reserve requirements. Higher trust reduces reserve burdens, while lower trust increases buffers.

### FIG. 4B—Insurance Pricing Adjustment

FIG. 4B illustrates adjustment of insurance premiums, deductibles, and coverage limits. Pricing reflects verified decision quality.

### FIG. 4C—Lending and Credit Adjustment

FIG. 4C illustrates modification of interest rates, collateral requirements, and credit limits. Favorable trust yields improved terms.

### FIG. 4D—Policy-Based Enforcement

FIG. 4D illustrates enforcement of policy and regulatory bounds on financial adjustments. Volatility and abuse are prevented.

### FIG. 4E—Financial Adjustment Recording

FIG. 4E illustrates creation of cryptographically signed financial adjustment records. Records support audit, supervision, and dispute resolution.

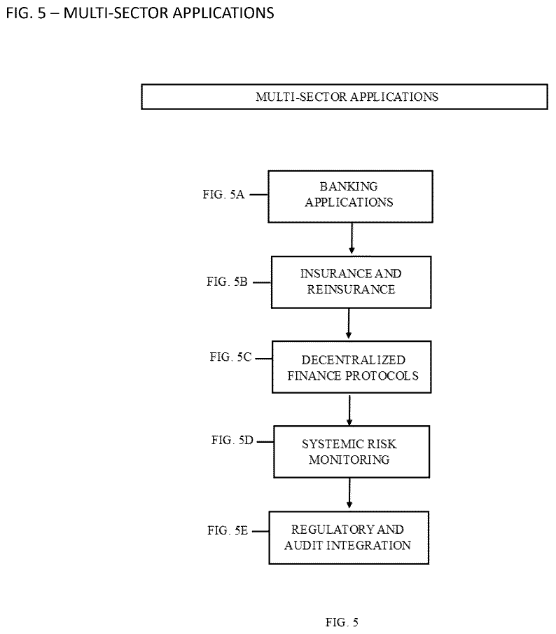

### FIG. 5—Multi-Sector Applications

FIG. 5 illustrates application across banking, insurance, and decentralized finance ecosystems. Trust-weighted capital becomes systemic infrastructure.

### FIG. 5A—Banking Applications

FIG. 5A illustrates dynamic credit and capital management in banking systems. Capital efficiency improves.

### FIG. 5B—Insurance and Reinsurance

FIG. 5B illustrates underwriting and reinsurance optimization. Loss volatility decreases.

### FIG. 5C—Decentralized Finance Protocols

FIG. 5C illustrates integration with DeFi smart contracts. Risk parameters self-adjust using trust scores.

### FIG. 5D—Systemic Risk Monitoring

FIG. 5D illustrates portfolio-level systemic risk monitoring. Trust degradation triggers Safeguards.

### FIG. 5E—Regulatory and Audit Integration

FIG. 5E illustrates integration with regulatory reporting systems. Adjustments are explainable and auditable.

### EXAMPLE

In one example, a multinational insurance and reinsurance provider underwrites professional liability coverage for hospital systems operating across multiple jurisdictions. Each hospital generates outcome attribution records reflecting adverse events, recovery outcomes, cost efficiency, and operational reliability, while governance signals reflect audit results and regulatory compliance.

The disclosed engine ingests these signals continuously, computes composite trust scores for each hospital system, and dynamically adjusts insurance premiums, deductibles, coverage limits, and reinsurance attachment points in near real time. Hospital systems demonstrating sustained high decision quality and governance compliance receive reduced premiums and expanded coverage, while declining trust automatically triggers increased pricing and reserve requirements.

All financial adjustments are recorded as cryptographically signed financial adjustment records and provided to reinsurers, regulators, and auditors. The insurer materially reduces loss volatility, improves capital efficiency, and creates a transparent, defensible underwriting model aligned with real-world performance rather than static historical assumptions.

1. A computer-implemented system for dynamic trust-weighted capital allocation and insurance underwriting, comprising:
a trust signal ingestion engine configured to receive cryptographically verifiable trust signals;
a verification layer configured to validate authenticity, integrity, and freshness of the trust signals;
a trust normalization and weighting engine configured to compute a composite trust score from the trust signals;
a financial adjustment engine configured to dynamically modify one or more capital allocation parameters or underwriting parameters based on the composite trust score; and
a governance and audit engine configured to generate cryptographically signed financial adjustment records and enforce regulatory or policy constraints.

2. A computer-implemented method for dynamic trust-weighted financial risk management, comprising:
ingesting cryptographically verifiable trust signals; verifying the trust signals using a verification layer; normalizing the verified trust signals; computing a composite trust score; dynamically adjusting at least one capital allocation parameter or underwriting parameter based on the composite trust score; and recording the adjustment as a cryptographically signed financial adjustment record.

3. A non-transitory computer-readable medium storing instructions that, when executed by one or more processors, cause performance of operations comprising:
ingesting and verifying trust signals;
computing a composite trust score;
dynamically modifying capital allocation parameters or underwriting parameters; and
generating an immutable financial adjustment record.

4. The system of claim 1, wherein the trust signals include outcome attribution records cryptographically linking real-world outcomes to prior decisions.

5. The system of claim 1, wherein the trust signals include governance compliance indicators or audit outcomes.

6. The system of claim 1, wherein the trust signals include influence signals representing decision authority or systemic impact.

7. The system of claim 1, wherein the financial adjustment parameters include insurance premiums, deductibles, or coverage limits.

8. The system of claim 1, wherein the financial adjustment parameters include capital reserve requirements, lending limits, or collateral thresholds.

9. The system of claim 1, wherein the trust normalization and weighting engine applies temporal decay to weight recent trust signals more heavily than historical trust signals.

10. The method of claim 2, further comprising applying a risk weighting function that adjusts the composite trust score based on volatility or uncertainty of the trust signals.
